(19) United States
(12) Patent Application Publication
(10) Pub. No.: US 2010/0082594 A1
(43) Pub. Date: Apr. 1, 2010

(54) BUILDING A TOPIC BASED WEBPAGE BASED ON ALGORITHMIC AND COMMUNITY INTERACTIONS

(75) Inventors: Tapan Bhat, Mountain View, CA (US); Scott Roy, Palo Alto, CA (US); Ingrid Lestiyo, San Francisco, CA (US); Deepa Joshi, Sunnyvale, CA (US); John Thrall, Sunnyvale, CA (US)

Correspondence Address: MPG, LLP AND YAHOO! INC., 710 LAKEWAY DRIVE, SUITE 200, SUNNYVALE, CA, 94085, US

(73) Assignee: Yahoo!, Inc., Sunnyvale, CA (US)

(21) Appl. No.: 12/238,234

(22) Filed: Sep. 25, 2008

(51) Int. Cl. G06F 7/10; G06F 17/30

(52) U.S. Cl. 707/707; 707/E17.014

(57) ABSTRACT

Methods and system for generating a topic page for a search query on a search webpage includes receiving a search query at the search engine on a server from a search webpage on a client. The search engine examines the query and categorizes the query along one or more dimensions. A plurality of modules having dynamic content and associated with the one or more categories is identified and a glue page is generated using the identified modules. The glue page is integrated into a topic page. The topic page is returned to the client where it is rendered at the search webpage in response to the search query.

### CROSS REFERENCE TO RELATED APPLICATION

This application is related to U.S. patent application Ser. No. 12/116,195 (Attorney Docket No.YAHOP056), entitled “Algorithmically Generated topic pages,” and to U.S. patent application Ser. No. 12/116,198 (Attorney Docket No. YAHOP057), entitled “Micro-Bucket Testing for Page Optimization,” assigned to the assignee, which is incorporated herein by reference in its entirety for all purposes.

### BACKGROUND

1. Field of the Invention

The present invention relates to internet searching, and more particularly, to generating a topic based webpage using a glue algorithm that assembles search content and browse content into an integrated topic based webpage.

2. Description of the Related Art

The vast amount of information distributed across the internet has lead to the development of the internet as an effective tool for search. A search engine includes a search tool for receiving a query with one or more keywords. The keyword(s) are used by the search tool to search a repository of information available to the search engine to identify and collect relevant information from the internet. The relevant information is returned as search results. The search tool is a software program that collects and indexes internet resources, such as webpages, newsgroups, programs, graphic images, videos, weblogs, etc., and provides a keyword indexed search system. The keyword indexed search system enables a user to identify and retrieve relevant internet resources based on words, phrases, or patterns within those documents and files.

The search results returned by the search engine are presented as a search list on a search result webpage in the matching order of the keyword(s) with the highest amount of match being at the top. Additional keywords may be used to further narrow the search results. The search result webpage may further include online advertisements that are relevant to the search keyword(s). The search results are returned as textual content with associated links to relevant websites that provide additional information associated with the search query. If a graphical or any other non-textual content is needed for a search query, then one must navigate to appropriate websites from the links provided by the search engine or access the website directly using a uniform resource locator (URL).

Further, the keyword indexed search system available to the search engine may engage a directory-based approach wherein a directory is searched to identify relevant topic or intent related pages from the internet. With the constant streaming of information on the internet, the directory based approach becomes tedious as all the information has to be updated onto the directory first before the information within the directory can be retrieved.

It is in this context that embodiments of the invention arise.

### SUMMARY

Embodiments of the present invention provide methods and computer implemented system that enable generating a topic page for search queries on a search webpage. The method employs a search algorithm that identifies and brings together a glue page with one or more content modules (modules) that match the search query. A search query is received at the search webpage on a client and transmitted to a search engine on a server. The search query is analyzed at the search engine to categorize the search query along one or more dimensions. The categories associated with the search query identify the purpose or intent of the search query and are categorized accordingly by one or more topics, one or more intents and geo location. The search engine uses the categories to identify one or more modules that match the categories of the search query. The identified modules include dynamic content information. A glue page is generated with the identified modules arranged in a two-dimensional layout. The glue page is integrated into a topic page, which is returned to the client for rendering in response to the search query.

It should be appreciated that the present invention can be implemented in numerous ways, such as methods or a system. Several inventive embodiments of the present invention are described below.

In one embodiment, a method for generating a topic page for a search query on a search webpage is disclosed. The method includes receiving a search query at the search webpage on a client. The query is transmitted from the search webpage on the client to a search engine on a server. The search engine examines the query and identifies one or more modules with dynamic information that match the search query. A glue page is generated for the identified modules. The identified modules are arranged in a two-dimensional layout on the glue page. The glue page with the identified modules is returned to the client in a topic page where it is rendered at the search webpage in response to the search query.

In another embodiment, a method for generating a topic page for a search query on a search webpage is disclosed. The method includes receiving a search query on the search webpage at a client. The search query is transmitted to a search engine on a server. The search engine analyzes and categorizes the search query along one or more dimensions. The search engine identifies one or more content modules with dynamic information related to one or more dimensions associated with the search query. The dynamic information associated with each of the identified modules related to the search query is obtained from a plurality of sources using a module gallery. The module gallery is a repository of pointers to the modules available at the corresponding plurality of sources. A glue page is generated with the identified modules arranged in a two-dimensional layout. The generated glue page is associated with one or more dimensions of the search query so as to enable subsequent rendering of the glue page for the search query. The glue page is returned to the client in a topic page for rendering in response to the search query.

In yet another embodiment, a system for generating a topic page for a search query on a search webpage is disclosed. The system includes a client with a user interface configured to receive a search query and transmit the query to a search engine. A search engine on a server receives the query from the client. The search engine includes a topic page generator that processes the search query and returns the topic page in response to the search query. The topic page generator includes an analyzer module, a module selector, a glue page generator/selector and a module ranker to help in identifying the appropriate modules and in generating the glue page. The analyzer module examines the search query and determines one or more categories associated with the search query. the module selector interacts with the analyzer module to determine the categories associated with the search query and identifies a plurality of content modules with dynamic information that match the one or more dimensions of the search query. The glue page generator/selector is configured to either select an already existing glue page associated with the one or more dimensions of the search query or to generate a new glue page with the modules identified by the module selector. The glue page generator/selector interacts with the module ranker and placer to rank and place the modules within the new glue page. The glue page is returned in a topic page to the user interface at the client for rendering, in response to the search query. The user interface on the client is also configured to render the topic page and to capture and transmit user interactions at one or more modules within the glue page of the topic page.

Thus, the embodiments of the invention provide a tool to generate a rich context based topic page by integrating the various content modules into a glue page and returning the glue page in a topic page for rendering in response to the search query. The topic page provides the glue page with most popular modules whose dynamic contents match the one or more categories of the search query. The modules include variety of contents including text, videos, graphics, newsgroup, music, etc. Further, the glue page may be customized to any user's desire and the customization for each user is maintained in a glue page repository so that the appropriate customizations of the glue page may be applied during subsequent search query.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a high-level block diagram of a system used in generating topic page for a search query, in accordance with one embodiment.

FIG. 2 illustrates a simplified block diagram for generating a glue page, in accordance with one embodiment.

FIG. 3A illustrates a simple block view of a topic page, in one embodiment of the invention.

FIG. 3B illustrates an actual topic page with a plurality of modules using a topic page generator, in one embodiment of the invention.

FIG. 4 illustrates a flow chart of process operations involved in generating a topic page for a search query, in accordance with one embodiment of the invention.

FIG. 5 illustrates a flow chart of process operations involved in generating a topic page for a search query, in accordance with an alternate embodiment of the invention.

### DETAILED DESCRIPTION

Broadly speaking, the embodiments of the present invention provide methods and computer implemented systems that enable generating a topic page in response to a search query on a search webpage. A search query (query) is received at the search webpage from a user interface on a client. The query is forwarded to a search engine on a server. The query is received at the server and analyzed at the search engine by a topic page generator to identify one or more categories along one or more dimensions. It should be understood that the topic page generator can be in the form of a code running on a server. Further, the topic page generator does not have to be integrally coupled to the search engine logic but be available to the search engine. The categories define the purpose of the search query and may identify one or more topics, intents and/or geo location for the search query. A plurality of content modules (modules) with dynamic content information that match the one or more categories of the search query are identified from a plurality of sources. A glue page is generated with the one or more identified content modules (modules) arranged in a two-dimensional layout. The glue page is returned in a topic page to the user interface on the client for rendering, in response to the search query. The rendered topic page provides information most relevant to the topic and possible intent of the search query.

Analyzing the query identifies the relevant topic, possible intent and/or a geo location of interest to a user. The identified topic and the possible intent of the query enable the topic page generator logic to return the most popular and relevant modules in a glue page for the query. The content of various modules within the glue page are varied in nature. The varied nature of the modules provides a rich contextual glue page that is most relevant to the user's search query. The embodiments of the invention further allows customization of a glue page by user and retains the customization for future rendering for the same search query by the user.

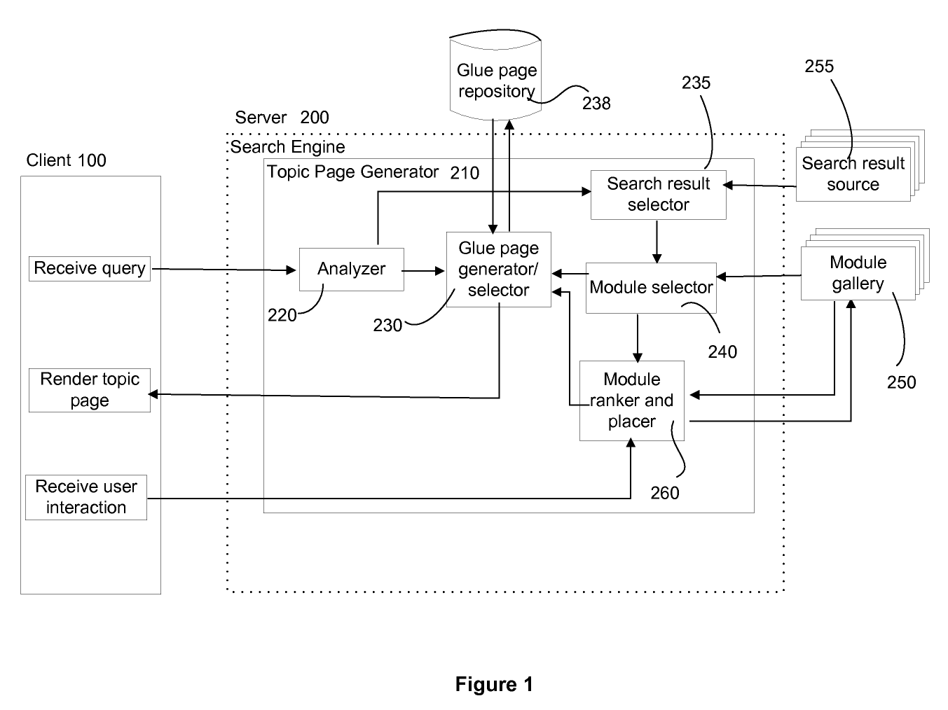

FIG. 1 illustrates a high-level block diagram of various functional elements of a computer system used in generating a topic page for a search query on a search webpage, in one embodiment of the invention. It should be understood that this is only an exemplary system, and should not be considered limiting. Other forms may also be possible, so long as the logic in processing can be carried out to generate the topic pages.

The system of FIG. 1 includes a client 100 with a user interface to receive and transmit a search query. The user interface is communicatively connected to a server 200 through a computer network (not shown), such as an Internet. The connection may be wired or wireless and may use any technology that allows the user interface to interact with the server. The user interface is also used to render a topic page with a glue page that is returned by the server in response to the search query and to capture user interactions at the glue page of a topic page rendered at the client 100.

The server 200 includes a search engine to receive the search query (query) from the client 100. A topic page generator 210 at the search engine processes the query. The topic page generator 210 may be integrated within the search engine or may be distinct from the search engine and may be available to the search engine for processing. The topic page generator 210 includes a plurality of modules, such as an analyzer module 220, a glue page generator/selector module (page selector) 230, a module selector 240, a module ranker and placer 260 and a topic page integrator 270. The analyzer module 220 is configured to receive, analyze and categorize the search query along one or more dimensions. The categories define the purpose of the search query and identify one or more topics, one or more intents and/or a geo location of interest to the user based on the search query. For instance, the purpose of the query may be to shop for better bargains, look for images, look for documentation, etc. It should be noted that the above list of categories should be considered exemplary. Other categories may be identified over time and the search query may be analyzed to identify the additional categories. The page selector module 230 receives the query and categories from the analyzer module 220, searches a glue page repository 238 available to the search engine to identify and select an existing glue page that matches the query. The glue page includes a defined set of modules that were determined during an earlier search using the same search query. The selected glue page is used to generate a topic page.

If an existing glue page is not available in the repository for the query, the page selector 230 is configured to create a glue page. In order to create a glue page, the page selector 230 interacts with a module selector 240 which, in turn, interacts with a module gallery 250 to identify one or more modules that match the query. In one embodiment, the module selector 240 chooses one or more modules by looking at the categories of the query. An algorithm or editorial team associates every combination of categories with a list of modules. For example, the query “iphone” might be categorized as “topic:product” and return a list of modules for shopping, product documentation, tips, and downloads. The query “iphone prices” might be categorized as “topic:product, intent:shopping” and return modules for shopping and reviews. The query “iphone san francisco” might be categorized as “topic:product, intent: shopping, geo: san francisco” and return modules that list sales for local stores. The module selector 240 forwards the selected modules to a module ranker and placer (ranker) 260 that ranks and places the selected modules using a glue page template available at the page selector 230. It should be noted that the ranker 260 may be distinct or may be integrated with the module selector 240. The glue page template is a default template that can be used for placing the selected modules. In one embodiment, the glue page template allows the modules to be arranged in a two-dimensional layout. The ranker 260 determines the ranking and placement of the selected modules within the glue page using a ranking algorithm. In one embodiment, the ranking algorithm may be based on how visually interesting the modules are on the glue page. In another embodiment, the ranking algorithm may be based on historical data that shows how often users click on each module. The newly generated glue page with its defined set of modules is returned to the glue page repository 238 for future retrieval and to the user interface on the client 100 as a topic page for rendering, in response to the query.

In one embodiment, one of the modules identified for the glue page is a search results module. The topic page generator 210 may also include a search result selector 235 to identify and select one or more search results that match the query. The search result selector 235 may be integrated within the topic page generator or may be distinct and be available to the topic page generator 210. The search result source 255 may be accessed through a network (not shown). The search result selector 235 integrates the search result into a search results module and forwards the search results module to the module selector 240, which in turn forwards the search results module along with all the other modules to the ranker 260 for ranking and placing the modules in the glue page.

The glue page is integrated into a topic page by the page selector 230. The topic page, thus created, includes the most popular and relevant modules for the search query as a whole. The topic page is returned to the user interface at the client 100 for rendering.

Upon rendering of the topic page at the client, one or more edits to one or more modules within the glue page of the topic page is received through user interaction at the client 100. The edits may reflect customization performed on the various modules within the glue page. Generally, the edits may be associated with content modification and layout modification. Some of the edits associated with layout modification may include addition of a module, deletion of a module, relocation of one or more modules, etc. The edits are received by the ranker 260 for dynamically ranking and placing of the modules within the glue page based on the edits. The edits are forwarded to the glue page repository 238 through the page selector 230 for storing so that the glue page with the defined set of modules and associated edits can be retrieved for subsequent rendering at the user interface in response to the search query by the user that made the edits, or, in some embodiments, by other users as well.

The content within the modules in the glue page may include any one or combination of textual information, audio content, video content, graphic images, or any other type of content that can be rendered on the search results webpage. In addition to various factual and informational contents, the modules may include sponsored advertisements from a plurality of sources that are relevant to the search query and the sponsored advertisements may, in turn, include audio, video, graphic or any other form of content that can be rendered on the webpage.

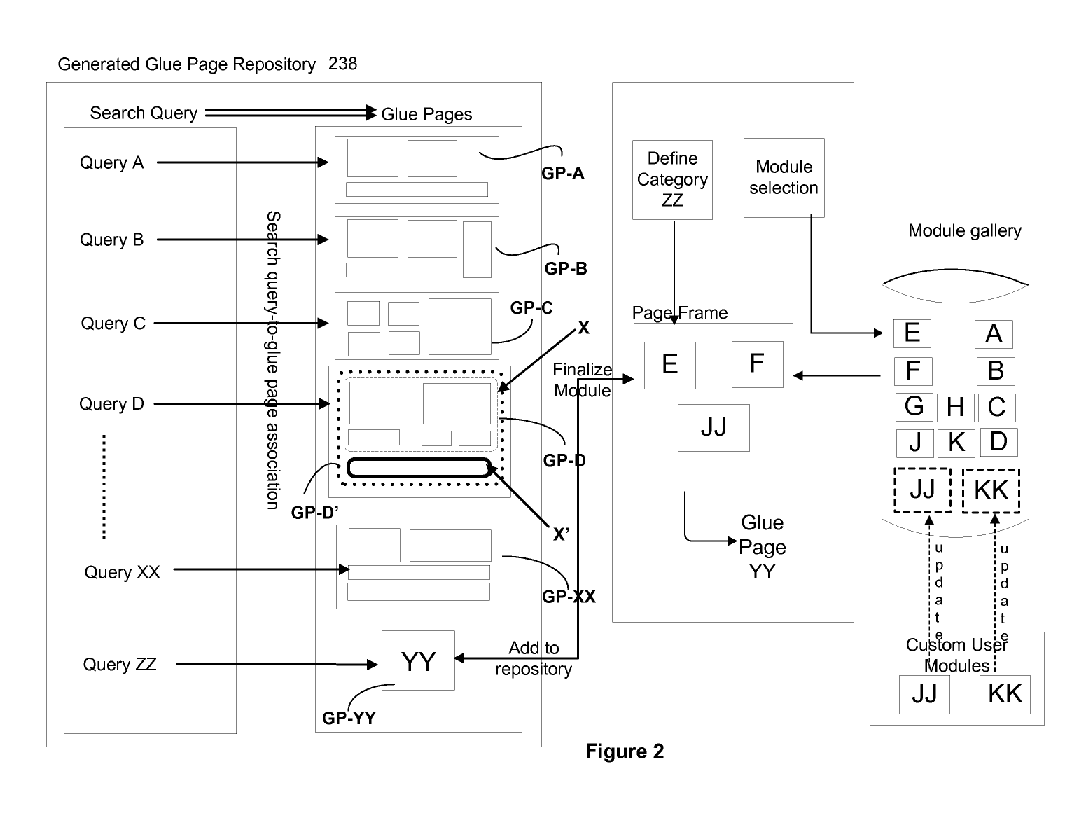

With the general understanding of the various functional elements of a computer system, the content and function of a glue page repository will now be described with reference to FIG. 2. The glue page repository 238 stores a plurality of glue pages for various search queries for varied users. The glue page repository stores the glue pages by mapping search queries to glue pages. For instance, as shown in FIG. 2 a search query, Query A, is mapped to a glue page, GP-A. search query, Query B, is mapped to glue page GP-B; search query, Query C, to GP-C, and so on. In addition to the standard glue pages, the glue page repository 238 includes one or more customized glue pages. A customized glue page includes edits to the contents of an existing standard glue page. As shown in FIG. 2, category D, is associated with a glue page, GP-D with a plurality of modules, X. A new module, X′, is added to GP-D as part of an edit by a user and the customized edited glue page is distinctly stored as GP-D′. The addition of one or more modules is part of customizing the glue page by the user to suit the user's needs and interests. The mapping of a search query to a glue page could be specific for a user to store these personal customizations. The original glue page, GP-D, may still be used by one or more users for the particular search query. As a result, the search query will return the original glue page, GP-D, for some users, and the customized glue page, GP-D′, for the user that modified the page, and for potentially other users. In addition to adding a module, the customization may also include deleting a module, relocating a module, etc.

In one embodiment, in addition to a plurality of modules that match the search query, the glue page may include custom modules. The custom module may be generated by a user and include content and format provided by the user. The custom module is generated by defining the content. The content may have any one or combination of varied content formats. The custom module is designed based on the content. The defined custom module is then updated in the module gallery available to a search engine on the server so that the custom module may be identified and retrieved during subsequent search queries.

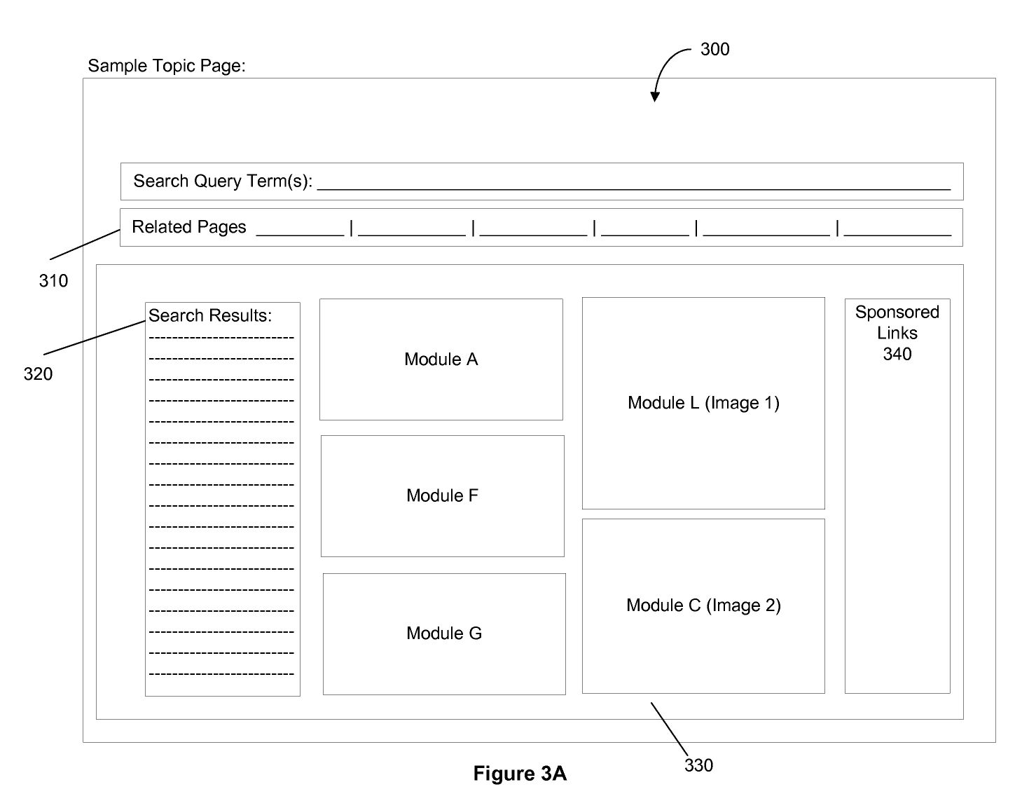

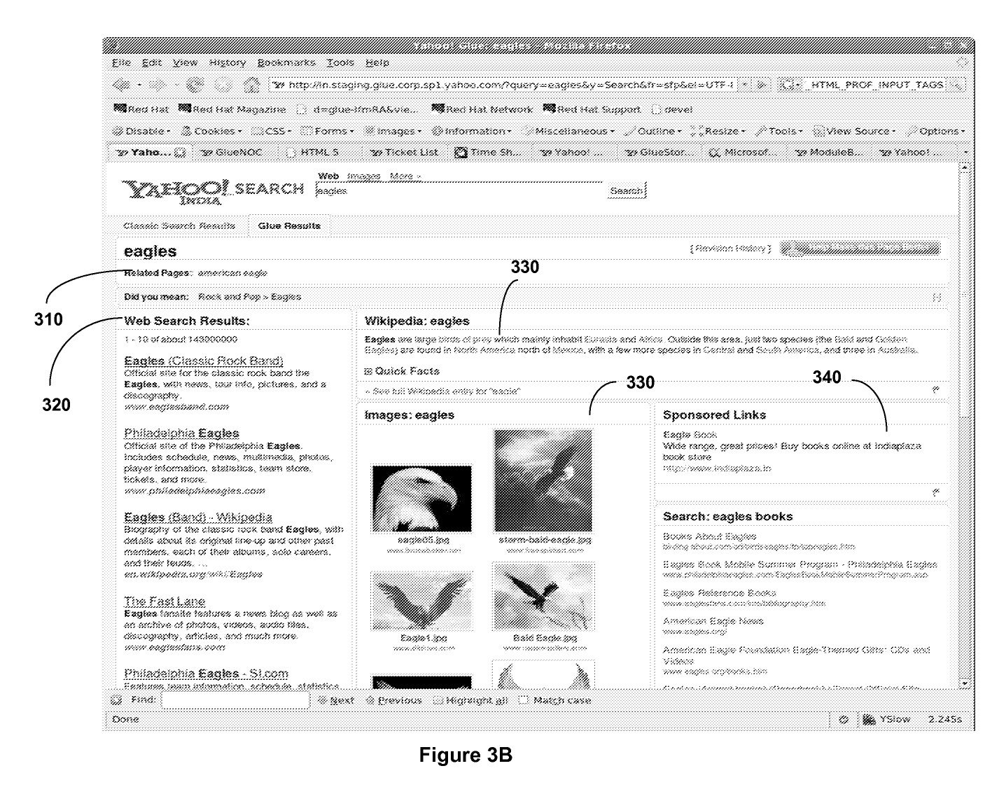

FIG. 3A illustrates a simplified block diagram of a typical topic page. The sample topic page 300 includes a glue page with a plurality of modules matching the one or more categories of the search query. The topic page is generated by a page selector that integrates the various modules of the glue page 330. In one embodiment, the modules within the glue page 330 may include a search results module 320 having one or more search results that match the one or more categories of the search query. In addition to the search results module 320, the glue page may also include a plurality of sponsored advertisements (sponsored links) 340. The sponsored links 340 may include a plurality of textual and non-textual content related to the one or more categories of the search query. These sponsored links may be identified and selected during the creation of the glue page. The topic page, in turn, along with the glue page may include a set of related pages 310 that may be associated with the one or more categories of the search query.

FIG. 3B illustrate a snapshot of an actual topic page for a search query, in one embodiment of the invention. As shown, the search query includes a search term “eagle” and a related page 310 associated with the search term, “American eagles,” is displayed. A search query is received at the search webpage and is categorized along a plurality of dimensions. A most popular category from the plurality of categories associated with the search query is identified. A plurality of modules associated with the popular category is identified and integrated into a glue page 330. In the embodiment shown in FIG. 3B, the most popular category for the search query is identified by a topic category, such as Eagle bird, and the modules associated with this category is obtained from a plurality of sources. In one embodiment, the glue page 330 includes a search results module 320. The search results module 320 identifies and integrates a plurality of search results associated with one or more categories of the search query which is rendered along with other modules in the glue page 330. The search results include textual information with links to respective webpage. The search query may include specific terms or may include ambiguous terms that encompass a plurality of categories. The search results 320 returned reflect results from the plurality of categories associated with the search query, such as links to Eagles rock band webpage, Philadelphia Eagles football team home page, etc.

The glue page may include a sponsored link module 340 in addition to the search results module 320. The sponsored link module 340 includes a set of sponsored links associated with the one or more categories of the search query. Thus, the topic page uses a glue algorithm to glue together a plurality of modules of varied content into a glue page to provide rich content that is associated with the most popular topic and related intents of the query. The topic page provides all the relevant information on a single webpage without having to navigate through multiple webpages for the relevant content.

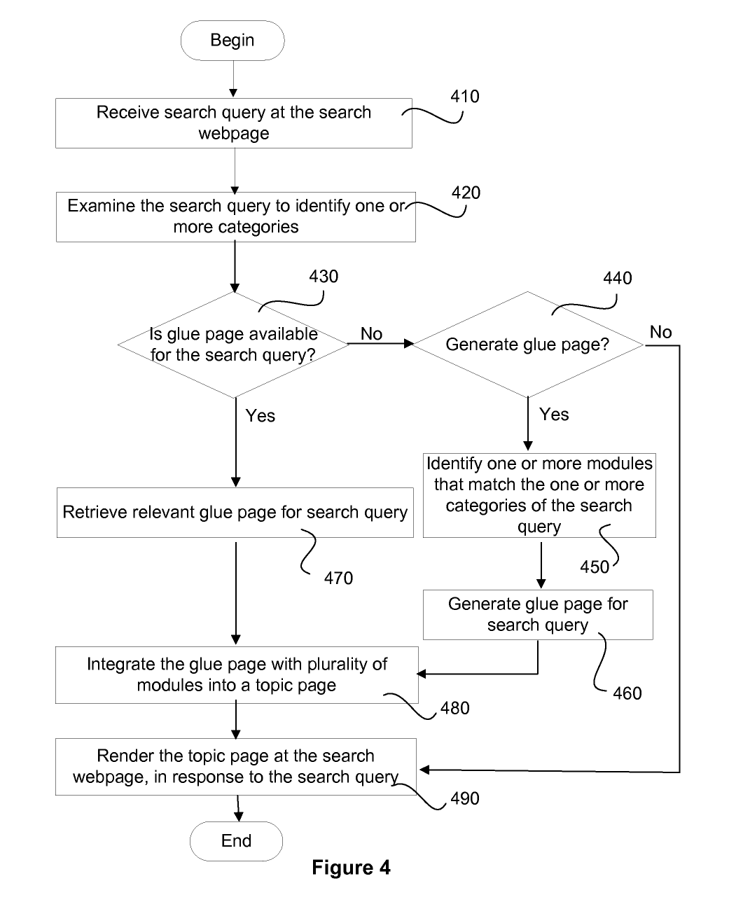

FIG. 4 illustrates a flowchart of process operations involved in generating a topic page for a search query. The process begins at operation 410 when a search query is received at the search webpage. The search query is examined to identify one or more categories, such as one or more topics, one or more intents, geo location, etc., of interest to the user, as illustrated in operation 420. A glue page repository is searched to determine if a glue page associated with the search query is available, as illustrated in decision operation 430. If a glue page is available, then the glue page is retrieved from the glue page repository, as illustrated in operation 470. The glue page is integrated into a topic page as illustrated in operation 480, and rendered at the client in response to search query, as illustrated in operation 490.

If, on the other hand, a glue page is not available in the glue page repository for the search query, then it is determined if a glue page should be generated for the search query, as illustrated in decision operation 440. If it is determined that a glue page needs to be generated for the search query, then one or more modules that match the categories of the search query are identified, as illustrated in operation 450, and a glue page is generated, as illustrated in operation 460. In one embodiment, the one or more modules are selected so as to match the most popular possible categories of the search query. The glue page is generated by retrieving the appropriate modules using a module gallery, ranking and placing the modules in a glue page template available at page selector. The generated glue page is integrated with other modules into a topic page, as illustrated in operation 480 and returned to the user interface for rendering at the client, as illustrated in operation 490.

If it is determined that the glue page should not be generated at decision operation 440, then process moves to operation 490 wherein a topic page is generated and returned to the client for rendering, in response to the search query. The process concludes with the successful rendering of the topic page at the user interface of the client. The topic page rendered at the client provides the most popular and optimized contents for the search query.

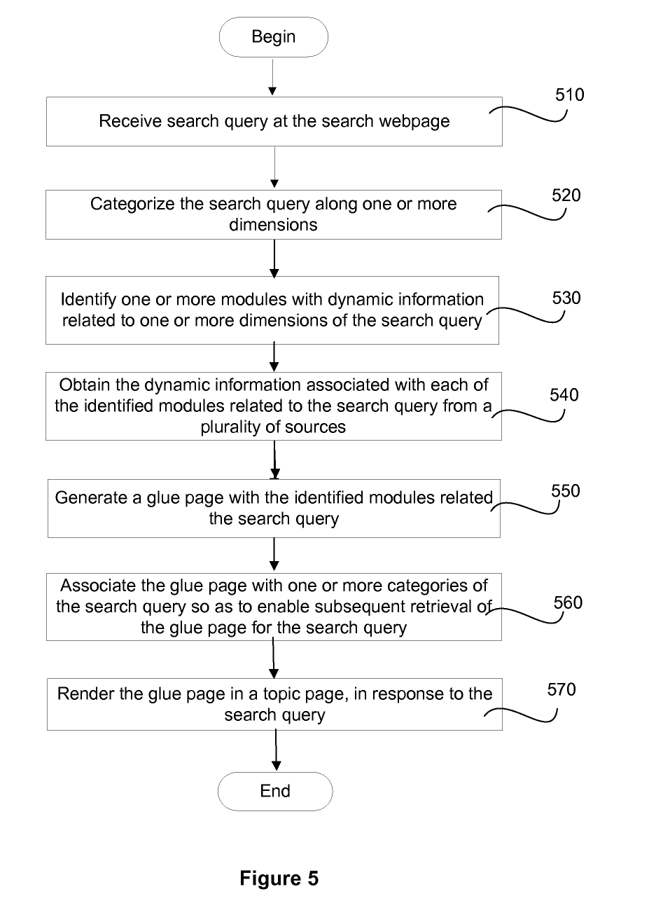

FIG. 5 illustrates a flow chart of operations involved in rendering a topic page for a search query at a search webpage, in one embodiment of the invention. The process begins at operation 510 when a search query is received at the search webpage. The search query is examined to identify one or more categories associated with the search query, such as one or more topics, one or more possible intents, geo location, etc that is of interest to the user, as illustrated in operation 520. A plurality of content modules (modules) with dynamic information matching the one or more categories of the search query are identified, as illustrated in operation 530. In this embodiment, it should be understood that there is no glue page with a defined set of modules available for the categories of the search query. As a result, the dynamic information associated with each of the identified modules is obtained from a corresponding source, as illustrated in operation 540 and a glue page is generated with the identified modules, as illustrated in operation 550. A glue page template available at a page selector may be used to generate the glue page and a ranker module may be used to rank and place the identified modules in the glue page template. The newly generated glue page is associated with one or more categories of the search query, as illustrated in operation 560. The newly generated glue page is integrated into a topic page and forwarded to the client in response to the search query. The topic page is rendered at the user interface of the client, as illustrated in operation 570. The newly generated glue page is stored in a glue page repository for subsequent rendering for the search query.

Upon receipt of the topic page, a user may customize the topic page to reflect the user's interest by editing one or more modules within the glue page. The edits may include adding a module, deleting a module, relocating a module, etc. The edits associated with the customization of the glue page are stored in a glue page repository along with the defined set of modules for the glue page for future retrieval and rendering for the search query.

Thus, embodiments of the invention provide a tool to generate topic page that is rich in content and relevant to the query. The topic page is optimized for one or more categories by analyzing the query to identify the various categories and including modules that are most relevant for the search query. The modules include dynamic content which are retrieved during rendering. The embodiments, thus, provide the most updated and relevant content for the search query while enabling a user to view the contents of varied nature all in a single topic page without having to navigate through multitude of pages. The modules are arranged in a glue page in a two-dimensional layout using a glue algorithm. It should be noted that the glue page is not restricted to any single format or layout but may be arranged in any format or layout.

It will be obvious, however, to one skilled in the art, that the present invention may be practiced without some or all of these specific details. In other instances, well known process operations have not been described in detail in order not to unnecessarily obscure the present invention.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for generating a topic page for a search query on a search webpage, comprising:
receiving the search query at the search webpage;
retrieving one or more modules associated with the search query, the modules having dynamic information content;
generating a glue page for the identified modules, the identified modules arranged on the glue page; and
rendering the glue page with the identified modules on the topic page in response to the search query.

2. The method of claim 1, wherein retrieving one or more modules further comprises,
categorizing the search query along one or more dimensions; and
selecting one or more modules based on the categories associated with the search query, the selected one or more modules having dynamic information.

3. The method of claim 2, wherein the categorizing along one or more dimensions includes categorizing based on one or more of topic, intent, and geo-location.

4. The method of claim 1, wherein retrieving one or more modules further includes,
identifying a defined set of modules associated with the search query, the defined set of modules determined during an earlier search using the search query, and
obtaining dynamic information associated with each of the modules in the defined set of modules.

5. The method of claim 1, wherein rendering the identified modules further includes,
determining a relative ranking of the identified one or more modules for the search query based on a ranking algorithm; and
defining a two-dimensional layout for the identified modules based on the relative ranking of the identified modules.

6. The method of claim 4, wherein the one or more modules within the defined set of modules include custom modules defined by a user.

7. The method of claim 4, further comprising:
capturing modifications to one or more modules associated with the defined set of modules as part of user customization, wherein the modifications to one or more modules include any one or combination of content modification and layout modification;
storing the modifications to the one or more modules associated with the defined set of modules; and
applying the modifications to the one or more modules during subsequent rendering of the desired set of modules for the same search query.

8. The method of claim 7, wherein the layout modifications include one or more of adding of a module, deleting of a module, relocation of one or more modules within the defined set of modules associated with the search query.

9. The method of claim 8, wherein the modifications for the defined set of modules is stored in a topic page repository for subsequent rendering for the search query.

10. The method of claim 2, wherein at least one of the modules includes search results associated with the search query, the search results matching the search query.

11. A method for generating a topic page for a search query on a search webpage, comprising:
receiving the search query at the search webpage categorizing the search query along one or more dimensions;
identifying one or more modules with dynamic information related to one or more dimensions of the search query;
obtaining the dynamic information associated with each of the identified modules related to the search query;
generating a glue page with the identified modules related to the search query, the identified modules arranged in a two-dimensional layout on the glue page; and
rendering the generated glue page in a topic page in response to the search query.

12. The method of claim 11, wherein the modules are arranged in the glue page based on a ranking algorithm, the ranking algorithm defining the relevancy of the modules to the search query.

13. The method of claim 12, further including storing the glue page in a glue page repository for subsequent rendering for the search query.

14. The method of claim 13, further including,
obtaining one or more edits to one or more of the modules in the glue page upon rendering of the topic page, the edits being part of user customization;
dynamically ranking and reconfiguring the modules within the glue page based on the edits using the ranking algorithm; and
storing the edits to the glue page in the glue page repository for use in subsequent rendering of the glue page for the search query.

15. The method of claim 11, wherein the modules in the glue page include one or combination of a search result module with search results that match the search query and a sponsored ad module with one or more links to sponsored ads that match the search query.

16. The method of claim 11, wherein the modules in the glue page include at least one custom module defined by a user.

17. The method of claim 16, wherein the custom module is obtained by,
defining content for the custom module;
designing the custom module based on the content; and
updating the module gallery with the custom module so that the custom module may be identified during subsequent search query.

18. A system for generating a topic page for a search query on a search webpage, comprising:
a client configured to generate a query, render a topic page and provide edits at the glue page within the rendered topic page;
a server with a search engine configured to receive the query from the client, the search engine including,
a topic page generator having,
an analyzer module configured to analyze and categorize the query along one or more dimensions, the one or more dimensions including one or more topics, one or more intents defining the purpose of the search query and a geo location;
a module selector configured to select a plurality of modules from a plurality of sources that match the one or more dimensions of the search query;
a glue page generator/selector module configured to one of select or generate a glue page that match the one or more dimensions of the search query, the glue page generator/selector module interacts with the module selector to obtain the modules for generating the glue page; and
a module ranker and placer having a ranking algorithm that is configured to define ranking and placement of the plurality of modules within the glue page,
wherein the glue page is returned in the topic page for rendering at the client in response to the search query.

19. The system of claim 18, further including a search result selector module to identify a plurality of search results from a plurality of sources that match the one or more categories of the search query and to integrate the plurality of search results into a search results module, the search results module is returned to the module selector for integrating into a glue page.

20. The system of claim 18, further including a glue page repository to store the glue page and any edits to one or more modules associated with the glue page, wherein the glue page generator/selector module interacts with the glue page repository to store and retrieve the glue page for rendering in response to the search query.

21. The system of claim 18, wherein content within the modules is dynamic, the content updated periodically at each of the corresponding plurality of sources.

22. The system of claim 18, further including a module gallery, the module gallery being a repository for storing pointers to one or more modules at a corresponding source.
